(19) United States
(12) Patent Application Publication
(10) Pub. No.: US 2002/0180752 A1
(43) Pub. Date: Dec. 5, 2002

(54) Device and method for displaying variable brightness characters

(75) Inventors: Frank Chernega, Yonkers, NY (US); Mohammad Alkhalili, Dumont, NJ (US)

Correspondence Address: Alan M. Weisberg, Christopher & Weisberg, P.A., Suite 2040, 200 East Las Olas Boulevard, Fort Lauderdale, FL, 33301, US

(73) Assignee: Pelco

(21) Appl. No.: 10/115,121

(22) Filed: Apr. 2, 2002

Related U.S. Application Data
(60) Provisional application No. 60/280,875, filed on Apr. 2, 2001.

(51) Int. Cl. G09G 3/36

(52) U.S. Cl. 345/589; 345/467

(57) ABSTRACT

A device and method for displaying variable brightness characters in a video surveillance system is provided. The system includes cameras coupled to a switch having video display monitors and a controller. The switch includes a digital logic unit for generating characters, receiving the input brightness, comparing the input brightness with a critical level, and controlling the appearance of the characters. The character generator produces pixel data that includes a body for the each character, and a dark border surrounding each character. The character data enters a shift register for processing prior to superposition with the video signal. Character brightness is variably selectable by a user. A comparator in the logic unit compares the input brightness with a preset critical level stored in the logic unit. If the input brightness is at or below the critical level, the comparator commands the shift register to remove the dark border from the characters.

### CROSS-REFERENCE TO RELATED APPLICATION

This application is related to and claims priority to U.S. Provisional Application Serial No. 60/280,875, filed Apr. 2, 2001, entitled VIDEO SYSTEM AND METHOD, the entirety of which is incorporated herein by reference.

### FIELD OF THE INVENTION

The present invention relates to video displays, and in particular, to a device and method for displaying variable brightness characters on a surveillance system video display.

### BACKGROUND OF THE INVENTION

Video surveillance systems often use character data and text symbols superimposed over a video signal. The resulting composite display of video and text information enables the system to deliver broader, more robust and often real-time information about a scene under surveillance, such as date, time, alarm conditions, scene conditions, and other information. The characters may be generated by a separate device or by the same processors and circuitry which control the central elements of the surveillance system, such as a keyboard controller, camera controller, or multi-purpose switch.

One way to produce high quality alphanumeric characters is to generate black outline characters, where bright characters are surrounded by a ring of dark video. In this way, the characters seem sharper and can be seen on bright backgrounds, such as a white cloud. In many systems, it is often advantageous to offer the ability to adjust the brightness of the symbols or characters. However, when the symbol brightness is reduced, it begins to look like the black outline, and the overall legibility and sharpness of the character text is reduced.

It is desirable therefore, to provide a device and method for displaying variable brightness characters on a video display, where the overall legibility and sharpness of the character text is not reduced when the character brightness is reduced past a critical level.

### SUMMARY OF THE INVENTION

The present invention advantageously provides a method and system for adjusting the display of character borders superimposed with a video signal.

According to an aspect, the present invention provides a device for generating characters on a video display. A character generator generates a first character data signal. A comparator has an input to receive a character brightness code in which the comparator compares the character brightness code with a reference code to produce a character shift command. A shift register is configured to receive the first character data signal from the character generator and to receive the character shift command from the comparator. The shift register produces a second character data signal in response to the character shift command.

According to another aspect, the present invention provides a video system which includes a camera producing a video signal, a keyboard controller, a video display unit, operatively connected to each other through a switch. The switch includes a character generator. The character generator generates a first character data signal. The switch includes a comparator which receives a character brightness code and compares the character brightness code with a reference code to produce a character shift command. The switch further includes a shift register which is configured to receive the first character data signal from the character generator, and to receive the character shift command from the comparator. The shift register produces a second character data signal in response to the character shift command.

In yet another aspect, the present invention provides a method of generating characters for a video display in which a reference brightness code is stored. A first character data signal corresponding to a first set of characters is generated. Each character includes a body and a border. The character brightness command is received. A character brightness code is generated corresponding to the character brightness command. The character brightness code is compared with the reference brightness code to determine a character shift command. The character shift command includes one of a no action command and a remove border command. A second character data signal is generated in response to the character shift command. The second character data signal is identical to the first character data signal if the character shift command includes the no action command. The second character data signal includes a second set of characters if the character shift command includes the remove border command.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein like elements have like reference designators:

FIG. 1 is a block diagram of an exemplary video surveillance system arranged in accordance with the principles of the present invention;

FIG. 2 is block diagram of the character generation and display processors in the logic unit and circuitry of the switch displayed in FIG. 1;

FIG. 3 is a flowchart of the character generation and display process controlled by the processors shown in FIG. 2; and

FIG. 4 is an exemplary embodiment of several characters of varying brightness displayed in a video background.

### DETAILED DESCRIPTION OF THE INVENTION

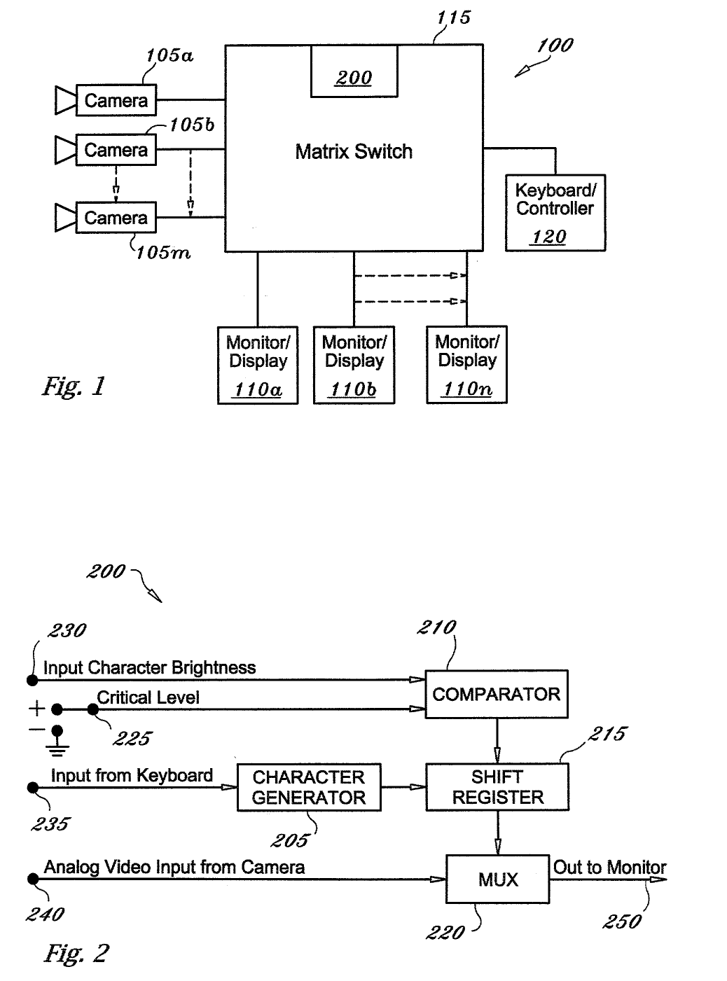

Referring now to the drawing figures, in which like reference designators refer to like elements, there is shown in FIG. 1 a block diagram of a video surveillance system, such as a closed circuit television (CCTV) system, for use in monitoring multiple scenes from multiple locations, constructed in accordance with the principles of the present invention and designated generally as 100. System 100 includes up to “m” video cameras 105a, 105b, through 105m, along with up to “n” video monitors or displays 110a, 110b, through 110n, (where “m” and “n” are whole numbers) coupled to a video switch, having at least one keyboard controller 120 connected thereto.

The cameras 105 maybe any of a variety of video or still cameras, acquiring a picture using a lens, iris, zoom and focus controls, integrated optics package, or other image acquisition device. The cameras 105 may be included inside of a housing such a semi-hemispherical dome, suitable for affixation onto a surface. The housing may also include a set of orientational controls, such as pan and tilt motors and actuators for moving and orienting the direction of the image acquisition device. An example of such a camera 105 and housing is the SPECTRA series of video surveillance units manufactured by Pelco.

Each camera 105 is connected to the video switch 115, such a multi-imput and output “matrix” switch. The switch 115 contains a variety of components, including a computer and control circuit electronics for controlling the operation of each camera 105, through commands and codes received by the keyboard controller 120. Both the cameras 105 and keyboard controller 120 may be disposed at remote locations from the switch 115. The switch 115 is further connected to a number “n” of monitor displays 110. The “matrix” therefore, contains m X n channels for m camera inputs and n monitor outputs. One example of such a matrix switch is the CM 6800 switch manufactured by Pelco, which provides m=48 and n=8. The keyboard controller 120 is further used to control the appearance of the video signals on the monitors 110, such the overall brightness, contrast, and the nature of the display of character text onto the images acquired by the cameras 105, as more filly described below.

The switch 115 includes a character generation control unit 200, for generating and controlling the character data to be displayed on the video signal acquired from the cameras 105. FIG. 2 is a block diagram of various elements included in the character generation control unit 200. The character generation control unit 200 includes a character generator 205, a comparator 210, a shift register 215, and a multiplexor (MUX) 220. The various inputs to these devices are a reference constant such as a three-bit constant, or “critical level” 225, an input character brightness code 230 such as a three-bit code, a stream of input commands from the keyboard controller 120 of FIG. 1, and a video signal 240. The resultant output 250 is a composite analog video signal with characters superimposed thereon.

The comparator 210 is preferably a 4-bit logic unit, such as a Field Programmable Gate Array (FPGA) device, programmed with Very-High Speed Integrated Circuit Hardware Description Language (VHDL) code. Only 3 bits are used, with 1 bit tied to the ground. The comparator reads the 3-bit input brightness command 230, representing a character brightness which is variable over discrete levels, such as 8 discrete levels, from “7” to “0” (or 111 to 000 represented in binary), with “7” being the highest level of character brightness, and a “0” being the lowest. The user of system 100 selects the character brightness using the keyboard controller 120 shown in FIG. 1. The user-selected input brightness, represented as the input brightness 230, is read into the comparator 210. Comparator 210 also reads a reference critical level 225, representing a preset threshold brightness level preprogrammed into the unit 200, and referenced to ground. While the critical level 225 may vary from “7” to “0”, a preferred setting is at level “2” brightness, or 010 in binary. The comparator 210 is arranged to compare input 230 with the critical level input 225. If input 230 is greater than critical level input 225, then the comparator sends a “border on” or “no action” command to the shift register 215. If the input 230 is greater than the critical level input 225, then the comparator sends a “border off” command to the shift register 215.

Character generator 205 generates a character data signal, namely, black and white pixel data representations for text characters and other desired symbols, according to a preprogrammed font set stored in a memory (not shown) in the switch 115. The character data generated by the generator 205 includes both the character pixels themselves, the “body” of the character, and a ring or of border pixels around the body. The ring of border pixels, or character border, is generally a set number of pixels, such as 2, that completely circumscribe and surround the body, with space in between, and are generally black pixels. Of course the present invention is not limited to black and white pixelized characters. Color characters can also be implemented as an aspect of the present invention.

The resulting character data, body and border, is routed into shift register 215. As long as the comparator sends a “border on” or “no action” command to the shift register 215, the character data sent by character generator 205 is unaltered and proceeds directly into the MUX 220 for superimposition with the camera video system. If however, the comparator 210 sends a “border off” or “remove border” command to the shift register 215, then the shift register removes the character border pixels, or shift such border pixels to represent video only.

The resulting character data signal, with or without borders, is then routed to the MUX 220 as shown. The entire process carried out by the comparator 210, character generator 205, and shift register 215 may be executed on one or more FPGA units, with each subcomponent programmed with a suitable code such as VHDL. In other words, the foregoing comparison of inputs 225 and 230 by comparator 210, character generation 205, and shifting by shift register 215 may all represent a FPGA implementation of a VHDL code.

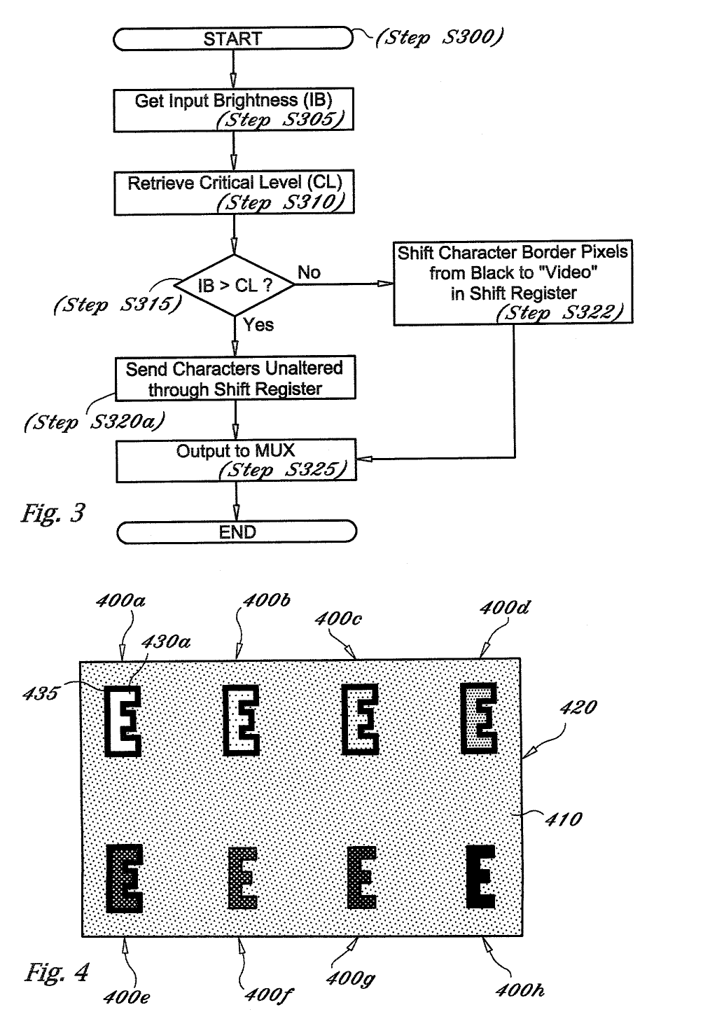

Once the digital character information enters the MUX 220, it is combined with the video signal 240 acquired from any one of the cameras 105. The MUX 220 thereafter superimposes the characters over the video, and a composite signal 250 is output to one or more of the monitors 110. The brightness of the characters displayed is adjusted by the video display circuitry connected to any one of the monitors 110, as adjusted by the user and corresponds to the selected input brightness code discussed in reference to FIGS. 2 and 3.

FIG. 3 shows a flowchart illustrating the process by which the characters are added to the video signal as discussed with regard to FIG. 2. The process starts at step S300, whereby the video surveillance system 100 of FIG. 1 is activated and acquires a video signal from one of the cameras 105 of FIG. 1. The signal is received by the matrix switch 115 for routing and processing therein. The user defines and selects a character brightness, and the comparator 210 reads the command code from the keyboard controller 120 representing such character brightness (“IB”) (step S305). At step S310, the comparator 210 retrieves the critical level (CL) brightness stored therein. The comparator determines the outcome of such comparison (step S315). If IB>CL, then the process proceeds to step S320, where the comparator 210 does not alter the characters routed through the shift register 215. If IB is less than or equal to CL, then the process proceeds to step S322, where the shift register removes the black border pixels from the character data produced by character generator 205, leaving a “no action”, or “video only” command instead. In either case, the process proceeds to step S325, where the character data is output from the digital logic circuitry of the character generation unit 200 to the MUX 220, and the character data is combined with the analog video signal.

FIG. 4 shows an exemplary representation of eight characters, 400a through 400h (referred to collectively herein as characters 400), superimposed on a video background 410 on a monitor viewing area 420. Each character 400a-400h includes a respective body 430a-430h, and may or may not include a border 435. The characters are of varying brightness. And in this embodiment of the present invention, the brightness levels vary in eight discrete levels from “7” to “0”. The following table sets forth the brightness levels for each displayed character 400:

| Character | Brightness (Decimal) | Brightness (Binary) |
|---|---|---|
| 400a | 7 | 111 |
| 400b | 6 | 110 |
| 400c | 5 | 101 |
| 400d | 4 | 100 |
| 400e | 3 | 011 |
| 400f | 2 | 010 |
| 400g | 1 | 001 |
| 400h | 0 | 000 |

As shown in FIG. 4, if the critical brightness level is set at “2” or 010, when the comparator 210 in FIG. 2 reads this critical level and compares the character brightness thereto, a character brightness of “2” or less results in a character without the dark border, as characters 400f, 400g, and 400h shown. It is understood, that although a 3 bit character brightness is discussed herein, a much wider, or narrower, range of character brightness may be implemented. Furthermore, critical brightness itself need not be stored in the device for automatic operation, but may be manual adjusted by the user through keyboard 120, or some other suitable input device. The present invention advantageously incorporates the character generation unit 200 in the matrix switch 115 to generate characters with dark borders which may be selectably turned on or off based on a comparison to a threshold brightness. This allows for easier viewing of characters imposed on a background signal that may vary greatly in brightness. To retain a measure of sharpness and legibility, the user may adjust the character brightness, which thereafter may trigger the character border to switch off if the adjusted brightness is lower than a threshold level, as elaborated above.

It should also be readily understood that the foregoing description of the invention is not strictly limited to video surveillance systems. Rather, the foregoing implementation of a character border around a character body of varying brightness, wherein such border is automatically turned off if the brightness is lowered beyond a set threshold, may be applied in any system which includes a video signal, a display device such as a monitor, and is connected by a network. The network may be wireless or wired, and may include other components to process and condition the video signal.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A device for generating characters on a video display, comprising:
a character generator for generating a first character data signal;
a comparator, the comparator having an input to receive a character brightness code, the comparator comparing the character brightness code with a reference code to produce a character shift command;
a shift register configured to receive the first character data signal from the character generator and to receive the character shift command from the comparator, the shift register producing a second character data signal in response to the character shift command.

2. The device of claim 1, wherein the character brightness code corresponds to a selected character brightness level, wherein the reference code represents a critical character brightness level and wherein the comparator is arranged to compare the selected character brightness level with the critical character brightness level, the character shift command including a no action command if the selected character brightness level is greater than the critical character brightness level, the character shift command including a remove border command if the selected character brightness level is less than or equal to the critical character brightness level.

3. The device of claim 2, wherein the first character data signal comprises first set of characters, and the second character data signal comprises a second or third set of characters, each character in the first set of characters having a set of body pixels representing the body of each character in the first set of characters and a set of border pixels representing a border around the body of each character in the first set of characters,
wherein the shift register is arranged to receive the no action command from the comparator to produce a second character data signal identical to the first character data signal, the second set of characters being identical to the first set of characters, and to receive the remove border command from the comparator to remove the set of border pixels from each character in the first character data signal, to produce a third set of characters having a set of body pixels representing the body of each character in the first set of characters.

4. The device of claim 2, wherein the selected character brightness level and critical character brightness level are three-bit quantities and the critical character brightness level is equal to 010₂.

5. The device of claim 2, wherein the character brightness code includes a plurality of bits having a maximum value, and the reference brightness code includes a plurality of bits, the reference brightness code being stored in the comparator as a quantity, the quantity being less than half the maximum value of the character brightness code.

6. The device of claim 1, further comprising:
a multiplexor unit electrically connected to the shift register and arranged to receive an analog video signal and to receive the second character data signal, the multiplexor unit combining the analog video signal and second character data signal to produce a composite video and character signal.

7. The device of claim 1, wherein the comparator is a programmable digital logic device.

8. The device of claim 7, wherein the comparator is included as a field programmable gate array programmed with a VHDL code program.

9. A video system, comprising:
a camera, the camera producing a video signal;
a keyboard controller;
a video display unit; and
a switch, the camera, keyboard controller and video display being operatively connected to each other through the switch, the switch including
a character generator for generating a first character data signal;
a comparator, the comparator having an input to receive a character brightness code, the comparator comparing the character brightness code with a reference code to produce a character shift command, and
a shift register configured to receive the first character data signal from the character generator, and to receive the character shift command from the comparator, the shift register producing a second character data signal in response to the character shift command.

10. The system according to claim 9, wherein the switch further includes a multiplexor unit electrically connected to the camera, the video display unit, and the shift register, the multiplexor unit combining the video signal and second character data signal to produce a composite video and character signal for output to the video display unit.

11. The system of claim 9, wherein the comparator is a programmable digital logic device incorporated into a portion of a field programmable gate array programmed with VHDL code.

12. The system of claim 9, wherein the character brightness code corresponds to a selected character brightness level, wherein the reference code represents a critical character brightness level, and wherein the comparator is arranged to compare the selected character brightness level with the critical character brightness level, and
wherein the character shift command is a no action command if the selected character brightness level is greater than the critical character brightness level, and the character shift command is a remove border command if the selected character brightness level is less than or equal to the critical character brightness level.

13. The system of claim 12, wherein the first character data signal comprises a first set of characters, each character in the first set of characters having a set of body pixels representing the body of each character and a set of border pixels representing a border around the body of each character, wherein the shift register is operable to remove the set of border pixels from each character in response to a no action character shift command.

14. The system of claim 13, wherein the video system is a video surveillance system.

15. The system of claim 14, wherein the video surveillance system is a closed circuit television system.

16. The system of claim 12, wherein the character brightness code includes a plurality of bits having a maximum value, and the reference brightness code includes a plurality of bits, the reference brightness code being stored in the comparator as a quantity, the quantity being less than half the maximum value of the character brightness code.

17. A method of generating characters for a video display, comprising,
storing a reference brightness code,
generating a first character data signal corresponding to a first set of characters, each character having a body and a border,
receiving a character brightness command,
generating a character brightness code corresponding to the character brightness command,
comparing the character brightness code with the reference brightness code to determine a character shift command, the character shift command including one of a no action command and a remove border command,
generating a second character data signal in response to the character shift command, the second character data signal being identical to the first character data signal if the character shift command includes the no action command, and the second character data signal being a second set of characters if the character shift command includes the remove border command.

18. The method of claim 17, further comprising the steps of
generating a video signal,
combining the second character data signal with the video signal to produce a composite video and character signal.

19. The method of claim 18, further comprising the steps of displaying the composite video and character signal on a video display unit.

20. The method of claim 17, wherein the character brightness code includes a plurality of bits having a maximum value, and the reference brightness code includes a plurality of bits, the reference brightness code being stored as a quantity, the quantity being less than half the maximum value of the character brightness code.
